(19) United States
(12) Patent Application Publication
(10) Pub. No.: US 2009/0256010 A1
(43) Pub. Date: Oct. 15, 2009

(54) COLD GAS-DYNAMIC SPRAY NOZZLE

(75) Inventors: George Golna, Chandler, AZ (US); Joshua Robinson, Mesa, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/102,368

(22) Filed: Apr. 14, 2008

(51) Int. Cl. B05B 1/00

(52) U.S. Cl. 239/589

(57) ABSTRACT

A new particulate spray system nozzle design for the spraying of an interior diameter of tubular components or confined spaces is provided. The nozzle includes a substantially linear input section and a substantially linear output section. The input section includes an inlet adapted for coupling to a heated gas supply line for the input of a heated gas. The input section has a longitudinal axis and an inner diameter for the passage therethrough of the heated gas. The output section is in fluidic communication with the input section and includes an outlet adapted for discharging a particulate spray toward a target surface. The output section has a longitudinal axis extending substantially perpendicular to the longitudinal axis of the input section and an inner diameter for the passage therethrough of the particulate spray.

### FIELD OF THE INVENTION

This invention generally relates to a cold gas-dynamic spray assembly, and more specifically relates to a cold-gas dynamic spray nozzle that can be used for spraying inside diameters of pipes, tubes or confined spaces.

### BACKGROUND OF THE INVENTION

Cold gas-dynamic spray processes use energy stored in high pressure compressed gas to propel fine powder particles at a high velocity. In a typical cold-gas dynamic spray assembly compressed gas is heated and fed via a supersonic gas jet to a convergent-divergent nozzle where the gas exits at a high velocity through a divergent exhaust tube. A high pressure powder feeder introduces a fine metallic powder material into the high velocity gas jet. During operation, these fine metallic particles remain at a temperature well below their melting temperature and are accelerated and directed to a target surface. When the particles strike the target surface, the kinetic energy of the particles is converted into plastic deformation of the particle, causing the particle to form a strong bond with the target surface. To achieve desired results, the particle size, density, temperature and velocity in the cold gas-dynamic spray system are balanced. During deposition the convergent-divergent nozzle through which the high velocity powder exits is positioned perpendicular to the surface to be coated in order to deposit the coating efficiently. The resulting coating is a dense, low oxide coating which is typically used to prevent corrosion or perform metal repair.

As previously stated, during the cold gas-dynamic spray coating process, the supersonic gas jet, and more particularly the nozzle through which the fine powder material exits, is positioned at near 90 degrees relative to the target surface onto which the coating is being deposited to provide for the buildup of the coating. Failure to position the nozzle near normal to the target surface may cause the powder material to bounce off the target surface. Accordingly, there exists a potential problem when spraying a coating onto an inside diameter of, for example, a pipe or other component of restricted size. Components such as these may not provide for proper positioning of the cold-spray assembly, and more particularly positioning of the nozzle exhaust at near normal to the target surface. Current cold-spray equipment may be too bulky and too long to deposit coatings on the inside diameters of various parts at a perpendicular angle, or normal to the target surface.

The super-sonic velocity of cold gas-dynamic spraying is achieved by a gas heater and a convergent-divergent nozzle designed to produce the super-sonic jet. The nozzle design is based on gas pressure and orifice size ratios. The current design uses a cylindrical gas heater plus the convergent-divergent nozzle and a divergent exhaust tube. The total length of the apparatus in most instance approaches 16 inches. The divergent exhaust tube creates divergence of the jet over a distance of about 5-6 inches. A number of velocity retarding shock waves from the super-sonic jet are produced in this divergent exhaust tube area and they slow down the velocity of the jet. Using this current system design, cold gas-dynamic spray coatings cannot be applied to inside diameters of pipes, or the like, or within confined spaces because may do not allow for the coating to be applied near normal, or at a near right angle, to the target surface.

Thus, there is a need for a cold gas-dynamic spray assembly that provides for spraying of a coating to inside diameters of components parts, such as tubes or pipes, or within confined spaces. In addition, there is a need for a cold gas-dynamic spray assembly that does not risk turbulence or additional velocity retarding shock waves that may be produced by lengthy or curved exhaust tube designs.

### BRIEF SUMMARY OF THE INVENTION

The present invention provides a cold-gas dynamic spray nozzle that can be used for spraying inside diameters of pipes, tubes or confined spaces.

In one embodiment, and by way of example only, the nozzle includes a substantially linear input section having an inlet adapted for coupling to a heated gas supply line for the input of a heated gas, and a substantially linear output section in fluidic communication with the input section. The input section having a longitudinal axis and defining an inner diameter for the passage therethrough of the heated gas. The output section defining an inner diameter for the passage therethrough of the particulate spray and having an outlet adapted for discharging a particulate spray toward a target surface. The output section further having a longitudinal axis extending substantially perpendicular to the longitudinal axis of the input section.

In yet another embodiment, and by way of example only, the nozzle includes a substantially linear input section having an inlet adapted for coupling to a heated gas supply line for the input of a heated gas and a substantially linear output section in fluidic communication with the input section. The output section further including a particulate inlet and adapted for discharging a particulate spray toward a target surface. The input section having a longitudinal axis and defining an inner diameter for the passage therethrough of the heated gas. The output section having a longitudinal axis extending substantially perpendicular to the longitudinal axis of the input section and defining an inner diameter for the passage therethrough of the particulate spray. The input section and the output section are formed as a single unitary piece having a convergent/divergent form.

In still another embodiment, and by way of example only, provided is a particulate spray system for the spraying of a particulate spray on an interior diameter of a tubular component or within a confined space. The system includes a gas heater including a gas inlet in fluidic communication with a heated gas supply line, a nozzle in fluidic communication with the supply line, and a powder feeder in fluidic communication with the nozzle. The gas heater is adapted for heating a gas passing therethrough the gas heater and supplying a heated gas to the heated gas supply line. The nozzle includes a substantially linear input section and a substantially linear output section in fluidic communication with the input section. The input section includes an inlet adapted for coupling to the heated gas supply line for the input of the heated gas. The input section includes a longitudinal axis and defining an inner diameter for the passage therethrough of the heated gas. The output section includes a particulate inlet in fluidic communication with the heated gas for the input of a particulate material. The output section is adapted for discharging the particulate spray toward a target surface. The output section includes a longitudinal axis extending substantially perpendicular to the longitudinal axis of the input section and defining an inner diameter for the passage therethrough of the particulate spray. The powder feeder is in fluidic communication with the particulate inlet of the nozzle for feeding a particulate material to the output section of the nozzle and into the flow of the heated gas passing therethrough.

Other independent features and advantages of the preferred assemblies will become apparent from the following detailed description, taken in conjunction with the accompanying drawings which illustrate, by way of example, the principles of the inventive subject matter.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of an exemplary cold gas-dynamic spray apparatus according to an embodiment; and

FIG. 2 is an enlarged view of a portion of the cold gas-dynamic spray apparatus of FIG. 1 according to an embodiment.

### DETAILED DESCRIPTION OF THE INVENTION

The present invention provides an improved nozzle for a cold gas-dynamic spray assembly. The improved nozzle can be used for the deposition of a coating using a cold gas-dynamic spray process on an inside diameter, for example, of a tube, a pipe or other confined space. A variety of different systems and implementations can be used to perform the cold gas-dynamic spraying process.

Cold gas-dynamic spray systems were originally developed at the Institute for Theoretical and Applied Mechanics of the Siberian Division of the Russian Academy of Science in Novosibrisk. The cold gas-dynamic spray process developed there was described in U.S. Pat. No. 5,302,414, entitled “Gas-Dynamic Spraying Method for Applying a Coating”. This patent describes an exemplary system designed to accelerate materials having a particle size of between 5 to about 50 microns, to be mixed with a process gas to ensure a density of mass flow rate of the particles 0.05 and 17 g/s-c^{m2} in the system. Supersonic velocity is imparted to the gas flow, with the jet formed at high density and low temperature using a predetermined profile. The resulting gas and powder mixture is introduced into the supersonic jet to impart sufficient acceleration to ensure a velocity of the particles ranging from 300 to 1200 m/s. The particles are projected against a target surface as close to a 90° angle relative to the target surface as possible. In this method, the particles are applied and deposited in the solid state, i.e., at a temperature which is considerably lower than the melting point of the powder material. The resulting coating is formed by the impact and kinetic energy of the particles which gets converted to high-speed plastic deformation, causing the particles to bond to the surface. The system typically uses gas pressures of between 5 and 20 atm, and at a temperature of up to 750 degrees F. As non limiting examples, the gases can comprise air, nitrogen, helium and mixtures thereof. Again, this system is but one example of the type of system that can be adapted to cold spray powder materials to the target surface.

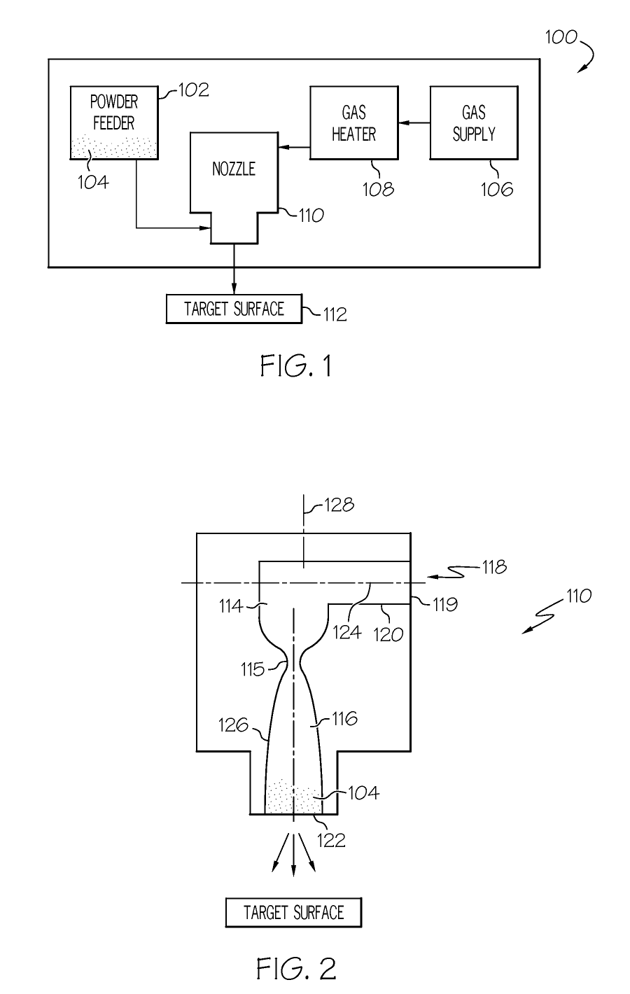

Turning now to FIG. 1, an exemplary cold gas-dynamic spray system 100 is illustrated schematically. The cold gas-dynamic spray system 100 is a simplified example of a type of system that can be used to coat inside diameters of pipes, tubes, or other confined spaces typically found within turbine components. Those skilled in the art will recognize that most typical implementations of cold gas-dynamic spray systems would include additional features and components. The cold-gas-dynamic spray system 100 includes a powder feeder 102 for providing powder particles 104, a carrier gas supply 106, which creates a moving stream of a carrier gas which passes through a heater 108, and a convergent-divergent nozzle 110. In some instances, a mixing chamber (not shown) may be included to mix the powder material with a suitable pressurized gas. During operation, the gas heater 108 heats the gas to a temperature less than the melting point of the powder particles 104. The particles are mixed with the gas, accelerated through the specially designed nozzle 110, and propelled by the nozzle 110 toward a target surface 112, for example, an interior diameter of a pipe found in a turbine component. When the particles 104 strike the target surface 112, the kinetic energy of the particles 104 is converted into plastic deformation of the particles 104, causing the particle 104 to form a strong bond with the target surface 112. Thus, the cold gas-dynamic spray system 100 may be used to coat and/or repair degraded areas in inside diameters of pipes, tubes, or other confined spaces.

The cold gas dynamic spray process is referred to as a “cold gas” process because the particles 104 are mixed and applied at a temperature that is well below the melting point of the particles 104. Thus, it is the kinetic energy of the particles 104 on impact with the target surface 112 that causes the particles 104 to deform and bond with the target surface 112, not the preexisting temperature of the particles 104 themselves. Therefore, the bonding is affected through solid state and there is no transition of molten droplet due to absence of requisite thermal energy.

The cold gas-dynamic spray system 100 can apply high-strength superalloy materials that are difficult to apply to the inside diameters of pipes, tubes, or other confined spaces. More specifically, in contrast to traditional cold gas-dynamic spray systems, the cold gas-dynamic spray system 100 disclosed herein includes the convergent-divergent nozzle 110 that is positioned relative to the gas heater 108 at a right angle to allow for spraying inside diameters of pipes or tubes as small as 5 inches, or other confined spaces. The convergent-divergent nozzle 110 is also shortened in contrast to traditional nozzle designs and does not include a separately formed exhaust tube. In a traditional system, simply bending an existing divergent exhaust tube at 90 degrees would not accomplish the same objective. Additional shock waves would be generated in a bent tube which would slow the jet to sub-sonic speed and also cause a buildup of the particles 104 inside the bent tube, therefore creating an obstruction.

Referring now to FIG. 2, illustrated is an enlarged sectional view of the convergent-divergent nozzle 110 of FIG. 1. It should be understood that such a nozzle can be used in any type of gas dynamic spray system, and not just the cold gas-dynamic system 100 described herein. In this particular embodiment, the convergent-divergent nozzle 110 is comprised of a wear resistant metal, such as stainless steel. The nozzle 110 includes an inlet opening 118 for the input of heated gas from the gas heater 108. The inlet opening 118 is positioned on a side 119 of the nozzle 110 so that it is formed at substantially 90 degrees relative to a nozzle outlet 122. An input section 120 in communication with the inlet opening 118 extends substantially linearly along a longitudinal axis 124. The input section 120 is in fluidic communication with an output section 126 that extends substantially linearly along a longitudinal axis 128 formed at a substantially 90 degree angle (perpendicular) to axis 124 and in communication with the nozzle outlet 122. The input section 120 and output section 126 are hollow and include an inner diameter sufficient for the passage therethrough of the particles 104. The input section 120 and the output section 126 define an internal convergent-divergent form and include a convergent portion 114 and a divergent portion 116, defining a throat 115 therebetween. The form is derived from the pressure-orifice ratios given by standard text book information available on supersonic nozzle design for minimum length nozzles. The particles 104 for the coating are preferably injected downstream of the throat 115 after the gas achieves supersonic velocity. The nozzle 110, and more particularly the divergent portion 116, is greatly shortened relative to standard system designs thereby reducing the resultant retarding shock waves.

The nozzle 110, and more particularly the input and output sections 120 and 126 that define the nozzle 110 may be formed from a metal or ceramic material, and may be formed by joining the sections together or fabricated as a single unitary piece. Each section may have any one of numerous shapes, including but not limited to having an internal cross-section in the shape of a cylinder, an ellipse, or a polygon, and may further include a liner to protect the inner surface against abrasion by the particulate flow therethrough.

The coupling of the new shortened convergent-divergent nozzle 110 at a substantially 90 degree angle to the gas heater 108 (FIG. 1) allows for the velocity of the accelerated particles above a critical speed to be maintained while permitting the formation of an even coating on the inside diameters of tubes, pipes, or other confined spaces. Rotation of the nozzle 110 at the coupling to the gas heater 108 allows for a compact design and the use of the assembly in conjunction with a pipe, tube, or confined space to deliver an even coating to the target surface.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims

What is claimed is:

1. A nozzle for use with a particulate spray system comprising:
a substantially linear input section having an inlet adapted for coupling to a heated gas supply line for the input of a heated gas, the input section having a longitudinal axis and defining an inner diameter for the passage therethrough of the heated gas; and
a substantially linear output section in fluidic communication with the input section, the output section having an outlet adapted for discharging a particulate spray toward a target surface, and a longitudinal axis extending substantially perpendicular to the longitudinal axis of the input section, the output section defining an inner diameter for the passage therethrough of the particulate spray.

2. A nozzle as claimed in claim 1, wherein the input section and the output section form a convergent/divergent nozzle.

3. A nozzle as claimed in claim 2, wherein the input section and at least a portion of the output section have a convergent form.

4. A nozzle as claimed in claim 3, wherein at least a portion of the output section has a divergent form.

5. The nozzle as claimed in claim 4, wherein the convergent form and the divergent form define a throat therebetween.

6. The nozzle as claimed in claim 1, wherein the output section further includes a particulate inlet adapted for coupling to a powder feeder and in fluidic communication with the heated gas for the input of a particulate material.

7. The nozzle as claimed in claim 1, wherein the input section and the output section are formed as a single unitary piece.

8. The nozzle as claimed in claim 1, wherein the input section and the output section are formed as separate components coupled one to another.

9. The nozzle as claimed in claim 1, wherein the particulate spray system is a cold gas-dynamic spray system.

10. A nozzle for use with a particulate spray system comprising:
a substantially linear input section having an inlet adapted for coupling to a heated gas supply line for the input of a heated gas, the input section having a longitudinal axis and defining an inner diameter for the passage therethrough of the heated gas; and
a substantially linear output section in fluidic communication with the input section, the output section further including a particulate inlet and adapted for discharging a particulate spray toward a target surface, the output section having a longitudinal axis extending substantially perpendicular to the longitudinal axis of the input section and defining an inner diameter for the passage therethrough of the particulate spray,
wherein the input section and the output section are formed as a single unitary piece having a convergent/divergent form.

11. A nozzle as claimed in claim 10, wherein the input section and at least a portion of the output section have a convergent form.

12. A nozzle as claimed in claim 11, wherein at least a portion of the output section has a divergent form.

13. The nozzle as claimed in claim 12, wherein the convergent form and the divergent form define a throat therebetween.

14. The nozzle as claimed in claim 10, wherein the output section further includes a particulate inlet adapted for coupling to a powder feeder and in fluidic communication with the heated gas for the input of a particulate material.

15. The nozzle as claimed in claim 10, wherein the particulate spray system is a cold gas-dynamic spray system.

16. A particulate spray system for the spraying of a particulate spray on an interior diameter of a tubular component or within a confined space, the system comprising:
a gas heater including a gas inlet in fluidic communication with a heated gas supply line, the gas heater adapted for heating a gas passing therethrough the gas heater and supplying a heated gas to the heated gas supply line;
a nozzle comprising:
a substantially linear input section having an inlet adapted for coupling to the heated gas supply line for the input of the heated gas, the input section having a longitudinal axis and defining an inner diameter for the passage therethrough of the heated gas; and
a substantially linear output section in fluidic communication with the input section, the output section further including a particulate inlet in fluidic communication with the heated gas for the input of a particulate material and adapted for discharging the particulate spray toward a target surface, the output section having a longitudinal axis extending substantially perpendicular to the longitudinal axis of the input section and defining an inner diameter for the passage therethrough of the particulate spray; and
a powder feeder in fluidic communication with the particulate inlet of the nozzle for feeding a particulate material to the output section of the nozzle and into the flow of the heated gas passing therethrough.

17. The system as claimed in claim 16, wherein the input section and the output section of the nozzle are formed as a single unitary piece having a convergent/divergent form.

18. The system as claimed in claim 17, wherein the convergent/divergent form defines a throat.

19. The system as claimed in claim 18, wherein the particulate inlet is formed on a portion of the output section below the throat.

20. The system as claimed in claim 16, wherein the particulate spray system is a cold gas-dynamic spray system.
